(19) United States
(12) Patent Application Publication
(10) Pub. No.: US 2015/0007104 A1
(43) Pub. Date: Jan. 1, 2015

(54) METHOD AND APPARATUS FOR SAVINGING WEB PAGE CONTENT

(71) Applicant: Tencent Technology (Shenzhen) Co., Ltd., Shenzhen (CN)

(72) Inventor: Zhigang Zhu, Shenzhen (CN)

(21) Appl. No.: 14/314,632

(22) Filed: Jun. 25, 2014

Related U.S. Application Data
(63) Continuation of application No. PCT/CN2014/070443, filed on Jan. 10, 2014.

(30) Foreign Application Priority Data
Jun. 28, 2013 (CN) 2013102688721

(51) Int. Cl. G06F 3/0486; G06F 3/0481; G06F 3/0488

(52) U.S. Cl. CPC G06F 3/0486; G06F 3/04886; G06F 3/0481
USPC 715/802

(57) ABSTRACT

A method and apparatus for saving web page content have been disclosed. The method including: displaying at least one cropping frame within a web page displayed in a touch screen of a mobile terminal, wherein the at least one cropping frame defines a shape and a size within which at least one portion of the web page that would be captured; tracing on the mobile terminal display, user's dragging movements applied to the at least one cropping frame, wherein the traced dragging movements resulting in adjustment to the at least one cropping frame over the at least one portion of the web page; executing at least one frame cropping operation in order to capture and to save an image as content of the at least one portion of the web page as defined within the cropping frame.

### CROSS-REFERENCE TO RELATED APPLICATIONS

The application is a continuation of PCT Application No. PCT/CN2014/070443, filed on Jan. 10, 2014, which claims priority to Chinese Patent Application No. 2013102688721, filed on Jun. 28, 2013, which is incorporated by reference in their entireties.

### FIELD OF THE TECHNOLOGY

The invention belongs to the field of browser technology; in particular, it involves a method and apparatus for saving web page content.

### BACKGROUND

Along with the rapid development of mobile communication technologies, cell phones have already become a necessity of work and modern life in many aspects of people's lives. For example, a user may use a cell phone browser to browse web pages and may bookmark a certain web page in order to browse the content of the web page later. Presently, a user may add the web address of such a web page to the Bookmarks or add the web address of such web page to the Favorites. When the user needs to browse such a web page, the user may acquire the content of such a web page by opening the web address of such web page in the Bookmarks or Favorites. Alternately, the user may like to share or blog the web page with comments on a social network by blogging a webpage link. However, the content on the web address may change or may become expired, thus the saved web address may become invalid. Consequently, the user and the viewer who receives the blog may no longer be able to see the content.

### SUMMARY

An embodiment of the disclosure discloses a method of saving web page content. The method including: displaying at least one cropping frame within a web page displayed in a touch screen of a mobile terminal, wherein the at least one cropping frame defines a shape and a size within which at least one portion of the web page that would be captured; tracing on the mobile terminal display, user's dragging movements applied to the at least one cropping frame, wherein the traced dragging movements resulting in adjustment to the at least one cropping frame over the at least one portion of the web page; executing at least one frame cropping operation in order to capture and to save an image as content of the at least one portion of the web page as defined within the cropping frame.

In another embodiment, the disclosure discloses an apparatus for saving web page content, which includes at least a processor operating in conjunction with at least a memory which stores instruction codes operable as plurality of modules, wherein the plurality of modules may include: a display module, which displays at least one cropping frame within a web page displayed in a touch screen of a mobile terminal, wherein the at least one cropping frame defines a shape and a size within which at least one portion of the web page that would be captured; an acquisition module, which acquires tracing on the mobile terminal display, user's dragging movements applied to the at least one cropping frame, wherein the traced dragging movements resulting in adjustment to the cropping frame; an adjustment module, which adjusts at least one cropping frame over the at least one portion of the web page according to the user's applied dragging movements; a cropping frame module, which executes at least one frame cropping operation in order to capture an image as content of the at least one portion of the web page as defined within the cropping frame; and a memory module, which saves the image corresponding to the at least one portion of the web page.

### BRIEF DESCRIPTION OF THE DRAWINGS

The accompanying drawings are included to provide a further understanding of the claims and disclosure, are incorporated in, and constitute a part of this specification. The detailed description and illustrated embodiments described serve to explain the principles defined by the claims.

FIG. 1 is an exemplary flow chart illustrating a method of saving web page content, according to an embodiment of the present disclosure.

FIG. 2 is an exemplary flow chart illustrating a method of saving web page content, according to another embodiment of the present disclosure.

FIG. 3 depicts an entire screenshot displayed on a mobile terminal browser to be saved as web page content, according to another embodiment of the present disclosure.

FIG. 4 depicts a frame cropping operation on a portion of an entire screenshot to be saved as web page content as illustrated in FIG. 3, according to another embodiment of the present disclosure.

FIG. 5 depicts a size adjustment of a cropping frame in saving web page content as illustrated in FIG. 3, according to another embodiment of the present disclosure.

FIG. 6 depicts a location adjustment of a cropping frame in saving web page content as illustrated in FIG. 5, according to another embodiment of the present disclosure.

FIG. 7 depicts an exemplary structural diagram of an apparatus for saving web page content, according to an embodiment of the present disclosure.

FIG. 8 depicts an exemplary structural diagram of an apparatus for saving web page content, according to another embodiment of the present disclosure.

### DETAILED DESCRIPTION OF THE EMBODIMENTS

The various embodiments of the present disclosure are further described in details in combination with attached drawings and embodiments below. It should be understood that the specific embodiments described here are used only to explain the present disclosure, and are not used to limit the present disclosure. In addition, for the sake of keeping description brief and concise, the newly added features, or features that are different from those previously described in each new embodiment will be described in details. Similar features may be referenced backward to the prior descriptions in a prior numbered drawing or referenced forward to a higher numbered drawing.

In order to clarify the object, technical scheme and advantages of the present disclosure more specifically, the present disclosure is illustrated in further details with the accompanied drawings and embodiments. It should be understood that the embodiments described herein are merely examples to illustrate the present disclosure, not to limit the present disclosure.

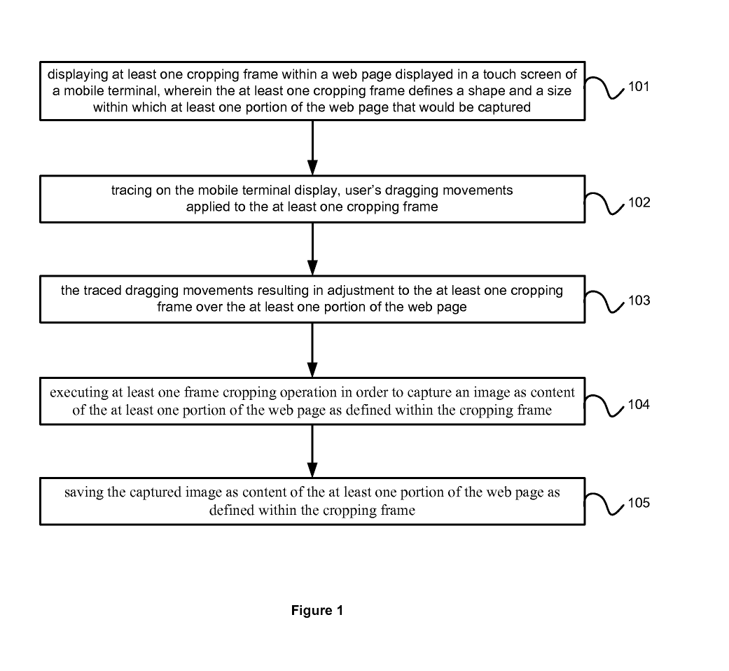

FIG. 1 is an exemplary flow chart illustrating a method of saving web page content, according to an embodiment of the present disclosure. The method includes at least the following exemplary steps:

Step 101: displaying at least one cropping frame (122C only or 122C and 122E in FIG. 4) within a web page (120) displayed in a touch screen of a mobile terminal (100), wherein the at least one cropping frame (100) defines a shape (e.g., a square or rectangle) and a size within which at least one portion of the web page (120) that would be captured.

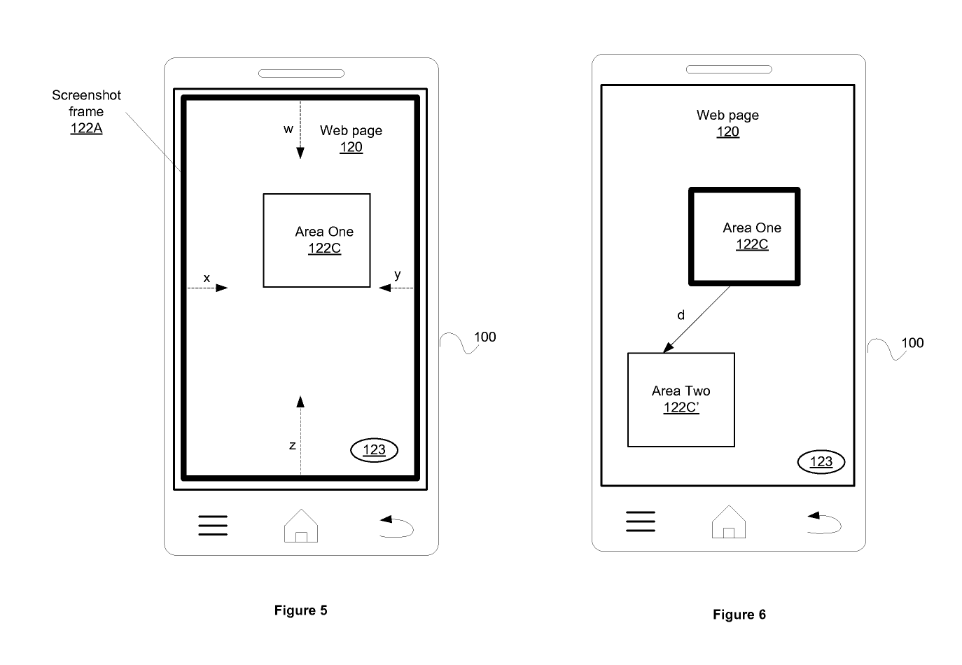

Step 102: tracing on the mobile terminal display, user's dragging movements (e.g., movements w, x, y and z in FIG. 5) applied to the at least one cropping frame (122C).

Step 103: adjusting the at least one cropping frame (122C) over the at least one portion of the web page (120) according to the traced dragging movements (e.g., movements w, x, y and z).

Step 104: executing at least one frame cropping operation in order to capture an image as content of the at least one portion of the web page as defined within the cropping frame (122C).

Step 105: saving the captured image as content of the at least one portion of the web page (120) as defined within the cropping frame (122C).

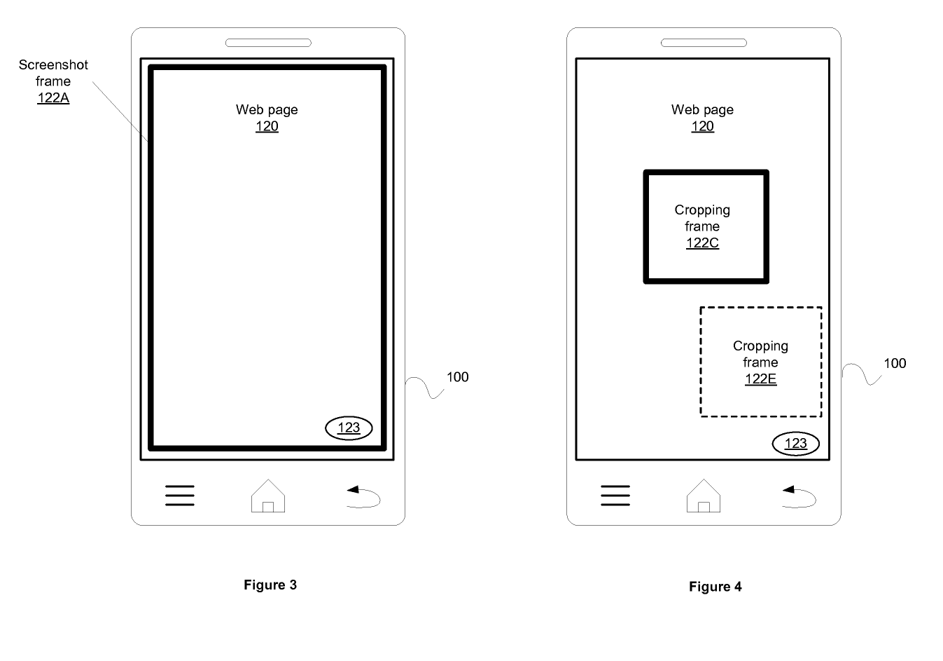

In brief, the web page (120) constitutes a screenshot frame (122A), wherein the cropping frame (122C) may occupy the entire screenshot frame (122A) (see FIG. 3), or may occupy only a portion of the screenshot frame (122C) (see FIG. 3) by adjustments. The adjustments of the cropping frame (122C) may be accomplished via tracing adjustment movements in the w direction (downward), the x direction (rightward), the y direction (leftward) and z direction (upward), as shown in FIG. 5, or diagonally (e.g., direction d as shown in FIG. 6). The adjustment to the at least one cropping frame may include: adjusting one or more of: a cropping frame size (e.g., via w, x, y, z adjustments), a cropping frame shape (rectangular, square, triangular, circular or irregular shape) and a cropping frame display location (e.g., 122C or 122C′) over the at least one portion of the web page (120).

More specifically, the capturing of the at least one portion of the web page defined within the cropping frame may include: acquiring the image corresponding to the at least one portion of the web page displayed in the touch screen of the mobile terminal; acquiring the image corresponding to the content of the at least one portion of the web page in the cropping frame, according to the cropping frame size and the cropping frame display location (e.g., via movement d from area One or cropping frame 122C to area Two or cropping frame 122C′) over the at least one portion of the web page (120).

In another embodiment, the saving of the image as the content of the at least one portion of the web page defined within the cropping frame may include: saving the image corresponding to the content of the at least one portion of the web page into a designated memory location of the mobile terminal

In another embodiment, after saving of the image as the content of the at least one portion of the web page, the method may further include: displaying a prompt to notify the user that the image has been saved.

Furthermore, in another embodiment, before the displaying of the at least one cropping frame within the web page displayed in the touch screen of the mobile terminal, the method may include one of: receiving a cropping frame command from the user via triggering a pre-configured function button in the web page, afterwards executing the cropping frame operation in the at least one portion of the web page displayed in the touch screen of the mobile terminal; or alternately, detecting a time duration the user touching the at least one portion of the web page displayed in the touch screen of the mobile terminal, if it is detected that the time duration exceeds a preset threshold, executing at least one cropping operation.

As seen in the embodiments of the above disclosure, the cropping frame (122C) may range in size from an entire screenshot frame (122A) displayed in a web page (120) of a mobile terminal (100); or selected only as a single portion (i.e., cropping frame 122C) or as more than one portions (i.e., cropping frames 122C and 122E) within the entire screenshot frame (122A) or the web page content (120). The user's applied traced dragging movements (in w, x, y, z or d directions) on the mobile terminal display (e.g., a touch screen) form the adjustment of cropping frame size, cropping frame shape and the final location of the cropping frame (122C) before saving the content of the web page (as an image, as text, or both).

A user may write his or her comments next to the saved content of the web page (i.e., next to the cropping frame (122C)) prior to posting the written comments with the cropping frame (122C) as multimedia microblog on a social website. The disclosed method enables viewers to be able to always view both the comments and the posted web page (i.e., the cropping frame 122C) content, without running into a problem of website address expiration or content changes over time. In addition, the cropping frame (122C) also helps to keep the microblog to a smaller file size without including the remaining contents of the web page (120) which may be irrelevant to the posted comments and wasting server resources.

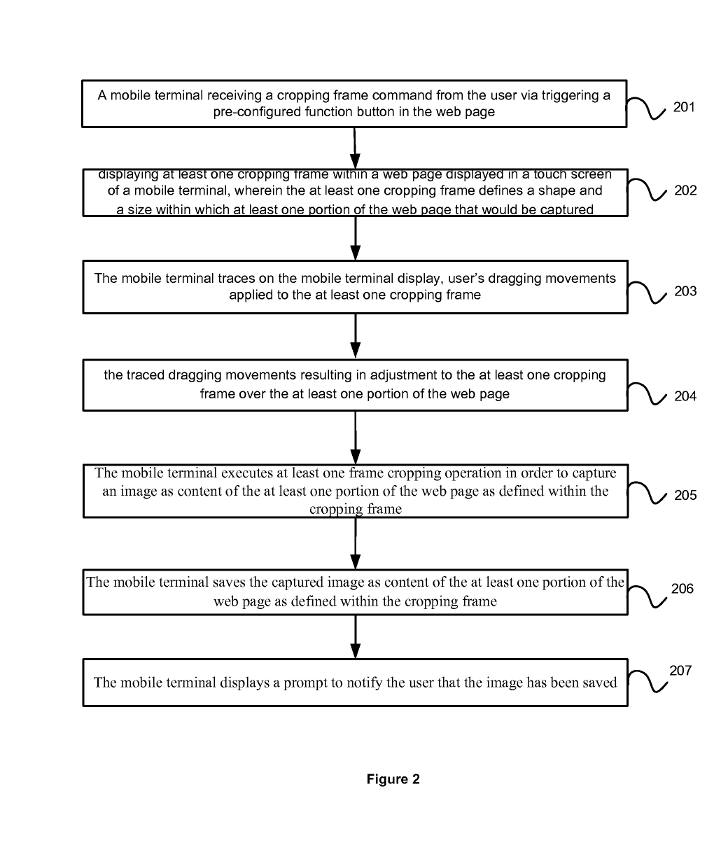

FIG. 2 is an exemplary flow chart illustrating a method of saving web page content, according to another embodiment of the present disclosure. Steps 202 to 206 of FIG. 2 are similar to steps 101 to 105 of FIG. 1. The method may include the following steps:

Step 201: A mobile terminal receiving a cropping frame command from the user via triggering a pre-configured function button (e.g., cropping frame button (123)) in the web page (120). Specifically, the mobile terminal (100) may receive a cropping frame command submitted by a click of a preset button (123) in the web page (120) by the user. The mobile terminal (100) may be any terminal with touch control functions on a touch-screen. The preset button may be a cropping frame button (123) displayed in the web page (120) of the mobile terminal; the preset threshold may be configured and changed according to system requirements.

When the user browses a web page (120) on the browser of the mobile terminal (100), the page displayed on the mobile terminal at this time is the web page (120). Such web page (120) may contain the cropping frame button (123). When the user plans to bookmark a certain web page in order to browse the content of the web page next time, the user may click the cropping frame button (123) contained in the web page to submit the cropping frame command.

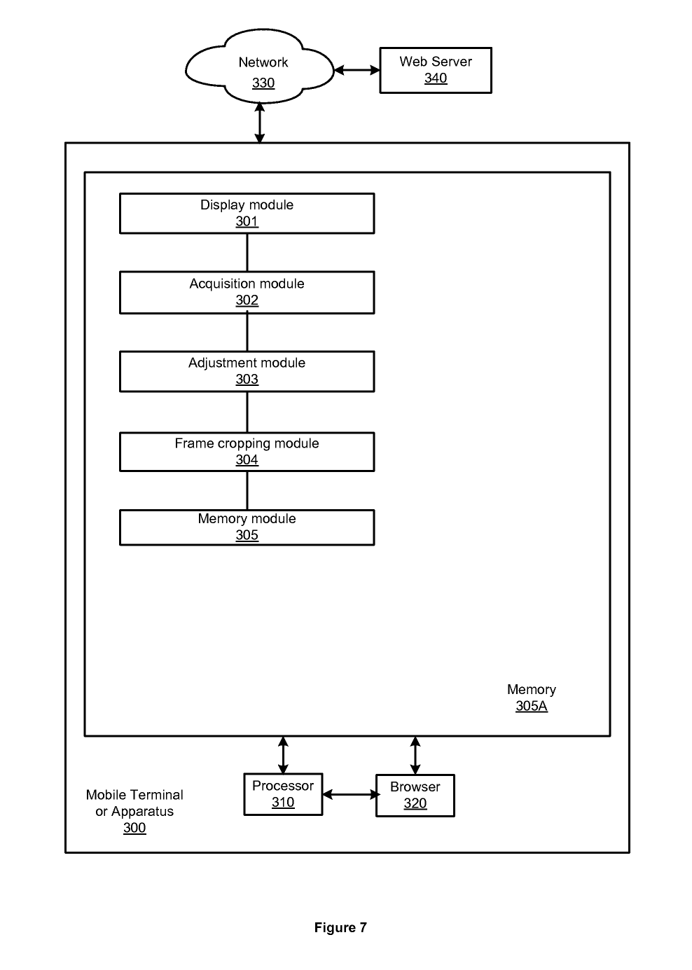

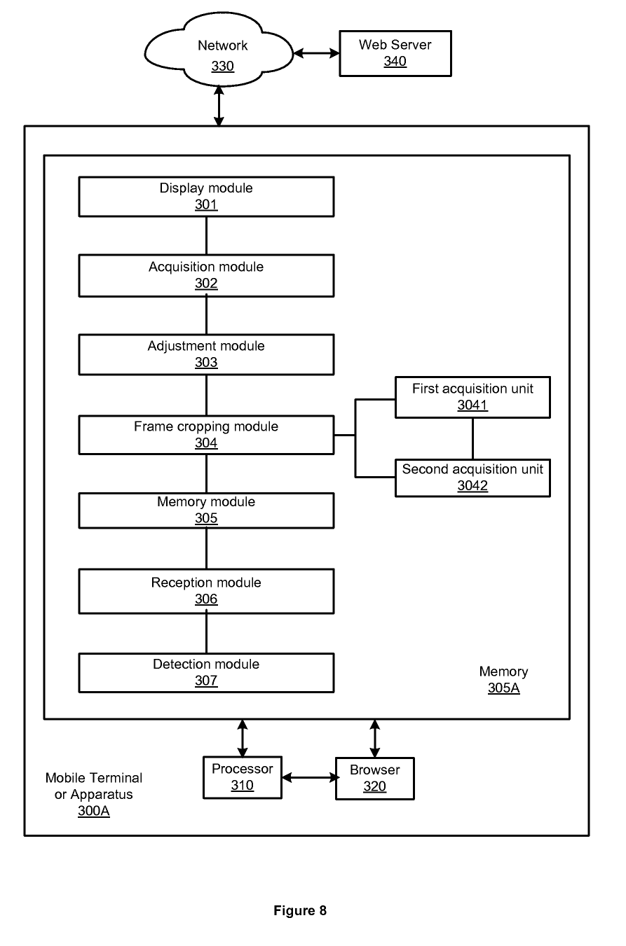

For example, in an embodiment of the present disclosure, a mobile terminal (100) having a touch-screen may have a preset duration threshold set for three seconds to trigger a cropping frame operation. The user may first open a browser (e.g., browser (320) in FIGS. 7 and 8) of the touch-screen terminal to browse a web page (120) with menu buttons including a cropping frame button (123). The user may click on the cropping frame button (123) to submit a cropping frame command.

Alternatively, the mobile terminal (100) may detect a time duration the user touching the at least one portion of the web page (e.g., cropping frame 122C) displayed in the touch screen of the mobile terminal (100), if it is detected that the time duration exceeds a preset threshold, executing at least one frame cropping operation. For example, the preset threshold may be set at three seconds to trigger submitting a cropping frame command.

When the mobile terminal (100) receives a cropping frame command submitted by the user (either through touching the cropping frame button (123) or through touching a portion of the web page exceeding the preset threshold), step 202 may be executed and a cropping frame (122C) may be appear and be displayed in the web page (120) of the mobile terminal (100).

Step 202: displaying at least one cropping frame (122C only or 122C and 122E in FIG. 4) within a web page (120) displayed in a touch screen of a mobile terminal (100), wherein the at least one cropping frame (100) defines a shape (e.g., a square or rectangle) and a size within which at least one portion of the web page (120) that would be captured.

As shown in FIG. 3, a cropping frame may be an entire screenshot frame (122A) which may include the content of the entire current web page (120) of the mobile terminal (100). The cropping frame area of the screenshot frame (122A) may be only a portion of the current web page (120), such as cropping frame (122C) as shown in FIG. 4. In another embodiment, the cropping frame area of the screenshot frame (122A) may also be more than one a portion of the current web page (120), such as cropping frames (122C, 122E) as shown in FIG. 4, wherein a user may trigger to open more than one cropping frame command to select more than one portion for web page content saving. The cropping frame (122C) may have a shape of a rectangle, a square, a triangle, a circle, an ellipse or an irregular shape.

Step 203: The mobile terminal traces on the mobile terminal display, user's dragging movements applied to the at least one cropping frame. For example, the size of the cropping frame (122C) may be adjusted by the user by dragging with a finger on the touch screen the boundary or edges of the cropping frame (122C). In addition, the location of the cropping frame (122C) may be adjusted or moved by the dragging movements (e.g., w, x, y, z and d directions as shown in FIGS. 5 and 6). The content within the cropping frame (122C) may be saved as web page content after the adjustments.

Specifically, the start location (e.g., area One location of cropping frame (122C) in FIG. 6) and end location (e.g., area Two location of cropping frame (122C′) in FIG. 6) of the cropping frame (122C) dragged by the user (e.g., dragged in direction d in FIG. 6) are traced as movements and acquired according to the start and end locations.

Wherein, prior to the mobile terminal (100) acquiring the traced dragging movements of the cropping frame (122C) by a user, the mobile terminal (100) may determine whether or not the cropping frame (122C) should be adjusted according to the location touched by the user. If the user has stopped dragging the cropping frame (122C) in the web page (120), step 205 may be executed, which the content of the web page within the cropping frame (122C) may be captured after executing the frame cropping operation.

In step 204: the traced dragging movements resulting in adjustment to the at least one cropping frame over the at least one portion of the web page. As shown in FIG. 3, the user may adjust the size of the cropping frame (122C) by dragging one or more of the borders of the screenshot frame (122A) in one or more of the directions w (downward), x (rightward), y (leftward) and z (upward), such as the web page content in “Area One” (i.e., cropping frame (122C)). An embodiment showing the process of dragging the screenshot frame (122A) to form the cropping frame (122C) may be illustrated in FIG. 5.

In addition, the user may adjust the display location of cropping frame (122C) by dragging from one location (i.e., Area One of cropping frame (122C)) to another location (i.e., Area Two of cropping frame (122C′)) such screenshot frame. For example, when the user needs to save the content of the web page in “Area Two”, the user may simply drag the cropping frame (122C) from “Area One” to cropping frame (122C′) in “Area Two” in direction d, as shown in FIG. 6.

In step 205: The mobile terminal executes at least one frame cropping operation in order to capture an image as content of the at least one portion of the web page as defined within the cropping frame (122C).

In step 206: The mobile terminal (100) may save the captured image as content of the at least one portion of the web page as defined within the cropping frame (122C) into a designated memory area (e.g., memory module (305) in FIG. 7). The designated memory area may be any memory area of the mobile terminal (100). Accordingly, the user may upload the acquired captured image from the designated memory with microblog comments which makes it convenient for the user to share such image via Weixin, Qzone, facebook, twitter, fanbox or other applications while other users may directly acquire the content of the web page by such image along with the microblog comments.

In step 207: The mobile terminal displays a prompt to notify the user that the image has been saved. For example, such prompt may be messages such as “screenshot successfully captured,” “saved,” etc. to remind the user that the image corresponding to the content of such web page has been saved.

The disclosed method enables a user to select the portion of web page content to be saved utilizing traced dragging movements function on a touch screen to adjust the size, shape and location of a cropping frame on the mobile terminal Moreover, the content of the web page being saved is acquired in the image file format which may not be lost or expired with time.

FIG. 7 depicts an exemplary structural diagram of an apparatus (300) for saving web page content, according to an embodiment of the present disclosure. In an embodiment, the apparatus may be a mobile terminal (300), such as a smart phone with a touch screen display. The apparatus (300) for saving web page content may include at least a processor (310) operating in conjunction with at least a memory (305A) which stores instruction codes operable as plurality of modules, wherein the plurality of modules at least include:
a display module (301), which displays at least one cropping frame (122C) within a web page (120) displayed in a touch screen of a mobile terminal (300), wherein the at least one cropping frame (122C) defines a shape and a size within which at least one portion of the web page (120) that would be captured;
an acquisition module (302), which acquires tracing on the mobile terminal display, user's dragging movements (i.e., w, x, y, z or d directions) applied to the at least one cropping frame (122C), wherein the traced dragging movements resulting in adjustment to the cropping frame (122C);
an adjustment module (303), which adjusts at least one cropping frame (122C) over the at least one portion of the web page (120) according to the user's applied dragging movements;
a frame cropping module (304), which executes at least one frame cropping operation in order to capture an image as content of the at least one portion of the web page as defined within the cropping frame (122C);
a memory module (305), which saves the image corresponding to the at least one portion of the web page (120).

FIG. 8 depicts an exemplary structural diagram of an apparatus (300A) for saving web page content, according to another embodiment of the present disclosure. The apparatus (300A) in FIG. 8 is similar to the apparatus (300) in FIG. 7 in many ways, except with further details on the frame cropping module (304), and further including a reception module (306) and a detection module (307).

More specifically, the frame cropping module (304) further include: a first acquisition unit (3041), which the image corresponding to the at least one portion of the web page displayed in the touch screen of the mobile terminal; a second acquisition unit (3042), which acquires the image corresponding to the content of the at least one portion of the web page in the cropping frame, according to the cropping frame size and the cropping frame display location over the at least one portion of the web page.

Furthermore, the memory module (305) may save the image corresponding to the content of the at least one portion of the web page into a designated memory (305) location of the mobile terminal The display module (301), may display a prompt to notify the user that the image has been saved.

Furthermore, the apparatus (300A) further includes: a reception module (306), which receives a cropping frame command from the user via triggering a pre-configured function button (e.g., button (123) in FIG. 4) in the web page (120), afterwards executing the cropping frame operation in the at least one portion of the web page displayed in the touch screen of the mobile terminal; a detection module (307), which detects a time duration the user touching the at least one portion of the web page displayed in the touch screen of the mobile terminal, if it is detected that the time duration exceeds a preset threshold, executing at least one cropping operation.

It is necessary to point out that: in the apparatus (100, 300 or 300A) for saving web page content as provided in the aforementioned embodiments, the various functional modules may be individually logically or physically divided or logically or physically combined as a single module.

It should be understood by those with ordinary skill in the art that all or some of the steps of the foregoing embodiments may be implemented by hardware, or software program codes stored on a non-transitory computer-readable storage medium with computer-executable commands stored within. For example, the disclosure may be implemented as an algorithm as codes stored in a program module or a system with multi-program-modules. The computer-readable storage medium may be, for example, nonvolatile memory such as compact disc, hard drive. ROM or flash memory. The computer-executable commands are used to enable a computer, server, a smart phone, a tablet or any similar computing device to accomplish the cropping frame web page content saving operations.

The foregoing represents only some preferred embodiments of the present disclosure and their disclosure cannot be construed to limit the present disclosure in any way. Those of ordinary skill in the art will recognize that equivalent embodiments may be created via slight alterations and modifications using the technical content disclosed above without departing from the scope of the technical solution of the present disclosure, and such summary alterations, equivalent has changed and modifications of the foregoing embodiments are to be viewed as being within the scope of the technical solution of the present disclosure.

1. A method of saving web page content, comprising:
displaying at least one cropping frame within a web page displayed in a touch screen of a mobile terminal, wherein the at least one cropping frame defines a shape and a size within which at least one portion of the web page that would be captured;
tracing on the mobile terminal display, user's dragging movements applied to the at least one cropping frame, wherein the traced dragging movements resulting in adjustment to the at least one cropping frame over the at least one portion of the web page;
executing at least one frame cropping operation in order to capture and to save an image as content of the at least one portion of the web page as defined within the cropping frame.

2. The method according to claim 1, wherein the adjustment to the at least one cropping frame comprising:
adjusting one or more of: a cropping frame size, a cropping frame shape and a cropping frame display location over the at least one portion of the web page.

3. The method according to claim 2, wherein the capturing of the at least one portion of the web page defined within the cropping frame, comprising:
acquiring the image corresponding to the at least one portion of the web page displayed in the touch screen of the mobile terminal;
acquiring the image corresponding to the content of the at least one portion of the web page in the cropping frame, according to the cropping frame size and the cropping frame display location over the at least one portion of the web page.

4. The method according to claim 1, wherein the saving of the image as the content of the at least one portion of the web page defined within the cropping frame, comprising:
saving the image corresponding to the content of the at least one portion of the web page into a designated memory location of the mobile terminal

5. The method according to claim 1, wherein after saving of the image as the content of the at least one portion of the web page, the method further comprising:
displaying a prompt to notify the user that the image has been saved.

6. The method according to claim 1, wherein before the displaying of the at least one cropping frame within the web page displayed in the touch screen of the mobile terminal, the method further comprising one of:
receiving a cropping frame command from the user via triggering a pre-configured function button in the web page, afterwards executing the cropping frame operation in the at least one portion of the web page displayed in the touch screen of the mobile terminal; or
detecting a time duration the user touching the at least one portion of the web page displayed in the touch screen of the mobile terminal, if it is detected that the time duration exceeds a preset threshold, executing at least one frame cropping operation.

7. An apparatus for saving web page content, comprises at least a processor operating in conjunction with at least a memory which stores instruction codes operable as plurality of modules, wherein the plurality of modules comprise:
a display module, which displays at least one cropping frame within a web page displayed in a touch screen of a mobile terminal, wherein the at least one cropping frame defines a shape and a size within which at least one portion of the web page that would be captured;
an acquisition module, which acquires tracing on the mobile terminal display, user's dragging movements applied to the at least one cropping frame, wherein the traced dragging movements resulting in adjustment to the cropping frame;
an adjustment module, which adjusts at least one cropping frame over the at least one portion of the web page according to the user's applied dragging movements;
a frame cropping module, which executes at least one frame cropping operation in order to capture an image as content of the at least one portion of the web page as defined within the cropping frame;
a memory module, which saves the image corresponding to the at least one portion of the web page.

8. The apparatus according to claim 7, wherein the adjustment module adjusts one or more of: a cropping frame size, a cropping frame shape and a cropping frame display location over the at least one portion of the web page.

9. The apparatus according to claim 8, wherein the frame cropping module comprises:
a first acquisition unit, which the image corresponding to the at least one portion of the web page displayed in the touch screen of the mobile terminal;
a second acquisition unit, which acquires the image corresponding to the content of the at least one portion of the web page in the cropping frame, according to the cropping frame size and the cropping frame display location over the at least one portion of the web page.

10. The apparatus according to claim 7, wherein the memory module saves the image corresponding to the content of the at least one portion of the web page into a designated memory location of the mobile terminal

11. The apparatus according to claim 7, wherein the display module displays a prompt to notify the user that the image has been saved.

12. The apparatus according to claim 7, further comprises:
a reception module, which receives a cropping frame command from the user via triggering a pre-configured function button in the web page, afterwards executing the cropping frame operation in the at least one portion of the web page displayed in the touch screen of the mobile terminal;
a detection module, which detects a time duration the user touching the at least one portion of the web page displayed in the touch screen of the mobile terminal, if it is detected that the time duration exceeds a preset threshold, executing at least one frame cropping operation.

13. A non-transitory computer-readable medium having stored thereon, a computer program having at least one code section being executable by a mobile terminal which causes the mobile terminal to perform saving web page content by a browser, comprising:
displaying at least one cropping frame within a web page displayed in a touch screen of a mobile terminal, wherein the at least one cropping frame defines a shape and a size within which at least one portion of the web page that would be captured;
tracing on the mobile terminal display, user's dragging movements applied to the at least one cropping frame, wherein the traced dragging movements resulting in adjustment to the at least one cropping frame over the at least one portion of the web page;
executing at least one frame cropping operation in order to capture and to save an image as content of the at least one portion of the web page as defined within the cropping frame.

14. The non-transitory computer-readable medium according to claim 13, wherein the adjustment to the at least one cropping frame comprising:
adjusting one or more of: a cropping frame size, a cropping frame shape and a cropping frame display location over the at least one portion of the web page.

15. The non-transitory computer-readable medium according to claim 14, wherein the capturing of the at least one portion of the web page defined within the cropping frame, comprising:
acquiring the image corresponding to the at least one portion of the web page displayed in the touch screen of the mobile terminal;
acquiring the image corresponding to the content of the at least one portion of the web page in the cropping frame, according to the cropping frame size and the cropping frame display location over the at least one portion of the web page.

16. The non-transitory computer-readable medium according to claim 13, wherein the saving of the image as the content of the at least one portion of the web page defined within the cropping frame, comprising:
saving the image corresponding to the content of the at least one portion of the web page into a designated memory location of the mobile terminal

17. The non-transitory computer-readable medium according to claim 13, wherein after saving of the image as the content of the at least one portion of the web page, the method further comprising:
displaying a prompt to notify the user that the image has been saved.

18. The non-transitory computer-readable medium according to claim 13, wherein before the displaying of the at least one cropping frame within the web page displayed in the touch screen of the mobile terminal, the method further comprising one of:
receiving a cropping frame command from the user via triggering a pre-configured function button in the web page, afterwards executing the cropping frame operation in the at least one portion of the web page displayed in the touch screen of the mobile terminal; or
detecting a time duration the user touching the at least one portion of the web page displayed in the touch screen of the mobile terminal, if it is detected that the time duration exceeds a preset threshold, executing at least one frame cropping operation.
